(19) United States
(12) Patent Application Publication
(10) Pub. No.: US 2019/0061301 A1
(43) Pub. Date: Feb. 28, 2019

(54) ARRANGEMENT AND METHOD FOR PROCESSING A WEB OF PACKAGING MATERIAL, AND A PACKAGING MATERIAL

(71) Applicant: Tetra Laval Holdings & Finance S.A., Pully (CH)

(72) Inventors: Peter Öhman, LUND (SE); Thomas Pettersson, STOCKAMÖLLAN (SE)

(21) Appl. No.: 15/771,989

(22) PCT Filed: Oct. 24, 2016
(86) PCT No.: PCT/EP2016/075548

§ 371 Date: Apr. 27, 2018

(30) Foreign Application Priority Data
Oct. 29, 2015 (EP) EP15192214.3
Nov. 2, 2015 (EP) EP15192604.5

(51) Int. Cl. B31F 1/07; B65H 20/02; B65H 20/34; B65H 23/188; B65H 26/02; B65H 37/00; B41F 19/02

(52) U.S. Cl. CPC B31F 1/07; B65H 2701/1944; B65H 20/34; B65H 23/1882; B65H 26/02; B65H 37/00; B41F 19/02; B31F 2201/0733; B31F 2201/0779; B31F 2201/0794; B31F 2201/0792; B65H 2301/5126; B65H 2301/543; B65H 2511/512; B65H 20/02

(57) ABSTRACT

The disclosure relates to a system for processing a ready-to-use web of a laminated packaging material including: a first rotatable roller and a second rotatable roller, wherein the web of laminated packaging material is wound from the first roller to the second roller a sensor for detecting a marking on the packaging material, said marking located at a predetermined position on said packaging material; at least one module arranged between the first rotatable roller and the second rotatable roller and configured to process the laminated packaging material; and a control unit connected to the sensor and the module. The control unit is configured to control the module based on the detected marking and/or information stored in the control unit. The disclosure also relates to a method for processing a ready-to-use web of a laminated packaging material, and a laminated packaging material.

### TECHNICAL FIELD

The invention relates to an arrangement and method for processing a web of ready-to-use packaging material, and a ready-to-use packaging material.

### BACKGROUND ART

Within packaging engineering, consumer packages of a disposable nature are commonly used for packaging and transporting liquid foods, such as, for example, milk. So-called disposable packages of this type are often made of a laminated packaging material comprising a base layer of paper or cardboard and outer liquid-tight layer of polyethylene. In special cases, such as with particularly oxygen-sensitive foods, for example fruit juice, it is necessary to supplement the packaging material with at least one further layer of a material having oxygen-tight properties, and the most common example of a supplementary material layer of this kind is an aluminium foil between the paper or cardboard layer and one of the two outer liquid-tight layers.

Consumer packages of this sort are nowadays very often produced with the aid of modern rational packaging machines of the sort which, from a web or from prefabricated blanks of the packaging material, both form, fill and also seal finished packages.

Formed, filled and sealed consumer packages are produced from a ready-to-use web of a laminated packaging material, for example, by the web firstly being transformed into a tube by joining together of the two longitudinal edges of the web into a longitudinal liquid-tight sealing joint (so-called lap joint). The tube is filled with the particular food, for example milk, and is divided into connected pillow-shaped pack units by repeated transversal heat sealings of the tube transversely to the longitudinal axis of the tube below the fill product level of the tube. The filled pillow-shaped pack units are separated from one another by cuts in the transverse seals and are subsequently given the desired geometric shape by means of at least one further forming and heat sealing operation. Well-known examples of commercial consumer packages of this kind are Tetra Brik and Tetra Classic packages, which are used to transport liquid foods of the type milk, fruit juice, wine and cooking oil.

A laminated packaging material of the sort which is described above is produced on an industrial scale from a roll of paper or cardboard in a converting process, i.e. a process resulting in the ready-to-use packaging material. A web of raw material, such as paper or cardboard, is unwound from the roll is led to a first work station where one side of the web, by suitable printing technology, is provided with a recurring pattern of an aesthetic and/or informative nature. In conjunction with or directly after the printing, the web is also provided with a likewise recurring pattern of weakening lines facilitating folding (so called fold lines). In order to give the subsequently produced disposable packages the desired shape and attractive appearance, it is important that these two recurring patterns are applied to the web in closest possible distance from each other.

The web provided with print and fold lines is led onward to a subsequent work operation, in which the web is coated on both sides with respective outer liquid-tight layers, usually polyethylene. In certain cases, such as when the packaging material is intended for packaging containers for particularly oxygen-sensitive products, the packaging material is also provided with at least one further layer of a material having such barrier properties, for example an aluminium foil, on one side of the packaging material between the paper or cardboard layer and one of the two outer liquid-tight coatings.

Finally, the packaging material web is divided up into individual partial webs, which are wound into finished packaging rolls in order to produce the formed, filled and sealed packaging containers.

In order to ensure that the packaging material in the finished packaging rolls meets set quality requirements and is not beset with serious faults and defects which could jeopardize the chemical and/or mechanical protection of the finished packaging containers, the packaging rolls are subjected to a quality control in which the packaging material is repaired by removing parts with errors.

A repair line of the conventional sort has a rotatable horizontal shaft at its one end and a corresponding rotatable horizontal shaft at its other end. Between the rotatable shafts, the repair line has a repair station, in which detected defects are to be removed and treated on a web of the packaging material. Since a packaging material can quite often be beset with a number of production faults and these production faults, in turn, can be found at randomly spread points on one and the same packaging material, this means that a web of the packaging material which is led through the repair station can be subjected to several repair operations where defects relating to the packaging material are overcome.

Today, many of these types of repair operations are made manually and are thus time consuming and often labour intensive. This is the case also regarding other post-converting operations performed for improving the quality and/or appearance of the packaging material.

### SUMMARY OF THE INVENTION

It is an object of the present invention to mitigate, alleviate or eliminate one or more of the above-identified deficiencies in the art and disadvantages singly or in any combination and solve at least the above mentioned problem.

According to a first aspect, these and other objects are achieved in full, or at least in part, by an arrangement for processing a web of a packaging material. The arrangement comprises a first rotatable roller and a second rotatable roller, the web of packaging material being wound from the first roller to the second roller, a sensor for detecting a marking on the packaging material, at least one module arranged between the first rotatable roller and the second rotatable roller, the module being arranged to process the packaging material, and a control unit connected to the sensor and the module. The marking is preferably provided at a predetermined position on the packaging material, and the control unit is adapted to control the module based on the detected marking and/or information stored in the control unit. The processing of the packaging material is accordingly completely automatized by means of the arrangement.

The arrangement may further comprise at least one tension control device, or dancer roller as they are called, adapted to provide a pressure onto the web of packaging material in a normal direction to the web of packaging material surfaces so as to provide a tension of the web of packaging material between the first rotatable roller and the second rotatable roller.

The arrangement may further comprise a third rotatable roller, wherein the web of packaging material is wound from the second roller to the third roller so as to rewind the web of packaging material.

The information stored in the control unit may be stored in a database. This way, the information is easily accessed and may be used as a reference when the control unit is to determine what kind of a process that is required for the packaging material and thus instruct the module how to behave. The module may comprise any one, or all, from the group consisting of a guiding unit, cutting device, splicing unit, a waste station, a printing device, an embossing device, and an adjusting device.

The guiding unit may be adapted to guide the web of packaging material of the first roller between a first direction and a second direction, the cutting device may be adapted to cut off the web of packaging material at a first predetermined position and at a second predetermined position, the wasting station may be arranged along the second direction and adapted to collect the web of packaging material being cut off between the first predetermined position and the second predetermined position, and the splicing unit may be adapted to splice the web of packaging material of the first roller back together with the web of packaging material of the second roller.

The arrangement may further comprise an anvil roller and an imprint roller which are arranged against each other to create a nip therebetween, the imprint roller having a mantel surface, i.e. a surface area, provided with an imprinting area, the imprinting area comprising protrusions forming an imprinting pattern, and a conveyor arrangement adapted to forward the web of the packaging material through the nip, so as to imprint a visual or tactile pattern on the packaging material corresponding to the imprinting pattern on the surface area. Here, the surface area may further be provided with a non-imprinting area designed to disengage the nip when the non-imprinting area is facing packaging material. According to an embodiment, the imprint roller has a surface area (sleeve) of metal, such as steel. According to a further embodiment the anvil roller has a hardness from 80 to 98 Shore A. This allows adjustment of the web position so that intended effects are in register with the packaging material (and the print design of the packaging material). According to an embodiment, the register alignment accuracy should be from ±1 mm to ±0.1 mm. Thus, the arrangement may further comprise an adjustment device arranged to adjust the position of said packaging material relative the imprint roller when said non-imprinting area of said surface area is facing said outermost layer of said packaging material, wherein the adjustment is based on the marking on the packaging material.

Adjusting the position of the web relative the imprint roller may be performed by adjusting the rotational position of the imprint roller.

According to a second aspect of the invention, the objects are achieved in full, or at least in part, by a method for processing a web of a packaging material. The method comprises the steps of guiding the web of packaging material between a first rotatable roller and a second rotatable roller, detecting a marking on the packaging material, and processing the packaging material based on the detected marking and/or information stored in a control unit. The marking is preferably provided at a predetermined position on the packaging material. The same advantages as described above for the arrangement also apply for this method.

The step of processing the packaging material may comprises one, or all, of the following steps aligning web of packaging material, cutting the web of packaging material, splicing the web of packaging material, printing the web of packaging material, embossing the web of packaging material, and aligning the web of packaging material.

The step of processing the packaging material may comprise cutting off the web of packaging material at a first predetermined position, guiding the web of packaging material of the first roller into a second direction, wasting the web of packaging material of the first roller by movement in the second direction to a waste station, cutting off the web of packaging material of the first roller at a second predetermined position, guiding the web of packaging material of the first roller back into the first direction, and splicing the web of packaging material of the first roller back together with the web of packaging material of the second roller at the first predetermined position. The automated method reduces labor needs and makes the method faster. Costs are thereby saved in two ways, both by reducing labor costs and by reducing the number of devices needed for removing defects in webs of packaging material. Human errors are also avoided, providing a higher degree of certainty that all errors in the web of packaging material have been removed. Better process control of the splices is also achieved so that the register of packages are intact, i.e. the splice is positioned in a position of the web corresponding to exactly one package so that only one package needs will end up having a splice.

The step of processing the packaging material may comprise forwarding the web of the packaging material through a nip provided between an anvil roller and an imprint roller which are arranged against each other, the imprint roller having a surface area provided with an imprinting area and a non-imprinting area, the imprinting area comprising protrusions forming an imprinting pattern, imprinting the imprinting pattern into an outermost layer of the packaging material through engagement with the protrusions forming an imprinting pattern of the surface area, as the web is passing through the nip, so as to imprint a visual or tactile pattern on the packaging material corresponding to the imprinting pattern of the imprinting area, and adjusting the position of the web when the non-imprinting area of the surface area is facing the packaging material. Adjusting the position of the web relative the imprint roller may be performed by adjusting the rotational position of the imprint roller.

The method has been developed in order to allow adjustment of the web position so that intended effects are in register with the packaging material (and the print design of the packaging material). Accordingly, the step of adjusting the position of the packaging material may be performed in register with a marking on the packaging material.

According to a third aspect of the invention, the objects are achieved in full, or at least in part, by a packaging material processed by the method described herein and/or using the arrangement also described herein.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a schematic view of an exemplary embodiment of an arrangement for processing a web of a packaging material according to a first aspect of the invention.

FIG. 2 is a schematic view of a tension control device of the arrangement.

FIGS. 3a and 3b are schematic views of another exemplary embodiment of the arrangement according to the first aspect of the invention. Here, the following modules are included in the arrangement: a guiding unit, cutting device, splicing unit, and a waste station.

FIG. 4 is a schematic view of another exemplary embodiment of the arrangement according to the first aspect of the invention. Here, the module is constituted by an embossing device.

FIG. 5 is a flow chart of a method for processing a web of a packaging material according to an exemplary embodiment of a second aspect of the invention.

### DETAILED DESCRIPTION OF PREFERRED EMBODIMENTS OF THE INVENTION

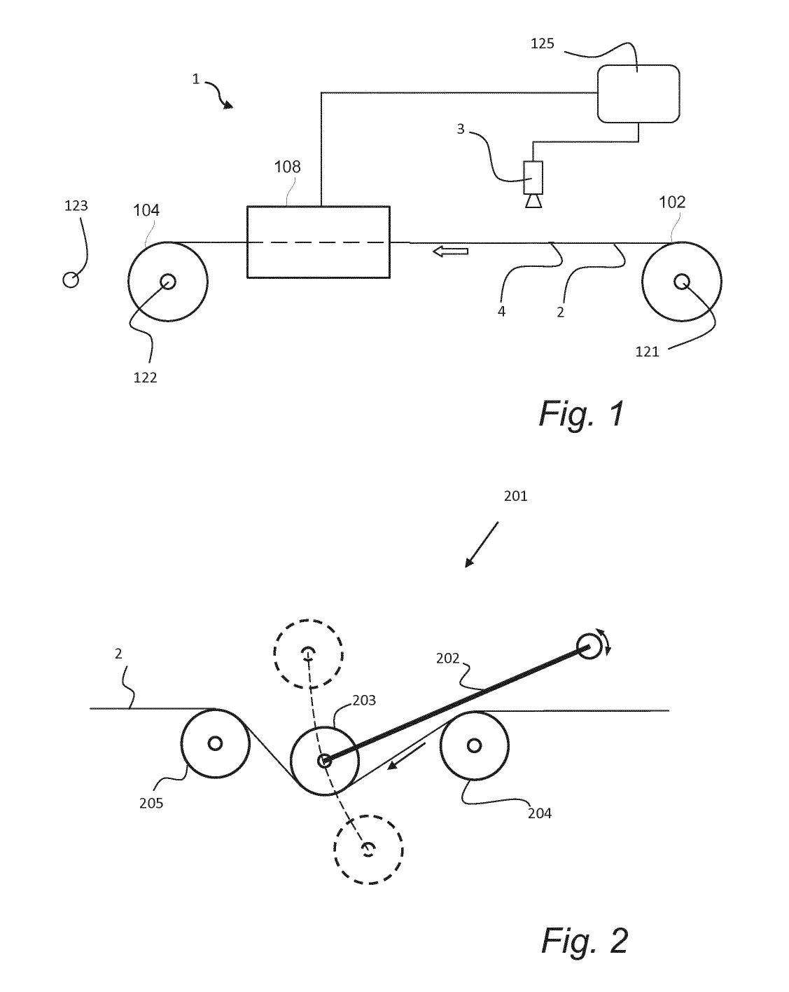

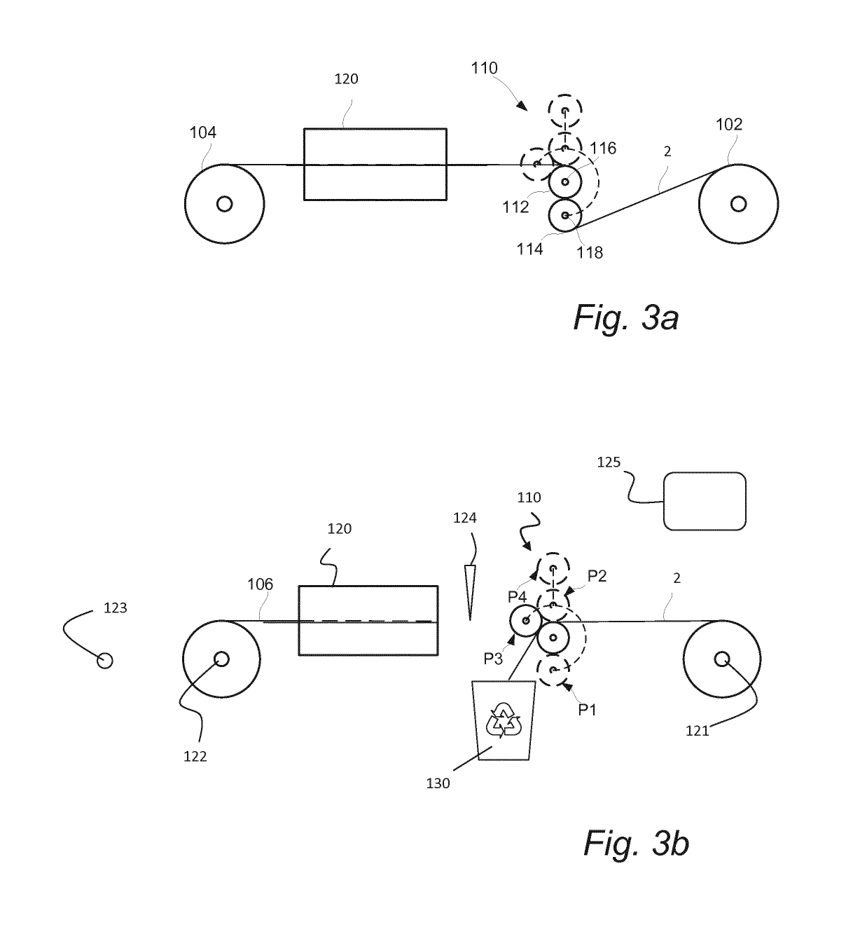

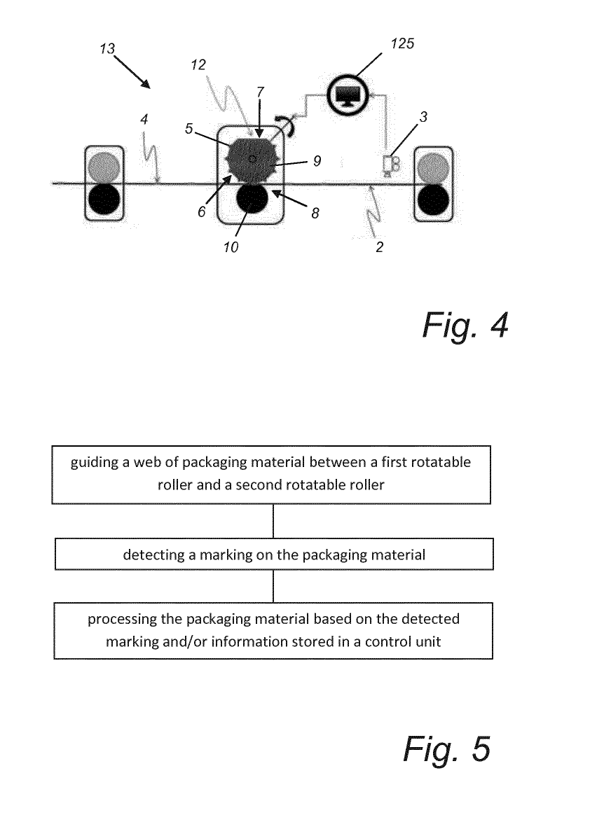

FIG. 1 illustrates an arrangement 1 for processing a web of a packaging material 2 according to an exemplary embodiment of the invention. The arrangement 1 comprises a first rotatable roller 121 and a second rotatable roller 122, and the web of packaging material 2 is wound from the first roller 121 to the second roller 122. Specifically, a reel 102 of web of a packaging material 2 is placed on a first rotatable roller 121. At start-up, the leading edge of the web is pulled by a robotic arm (not shown) to the second rotatable roller 122. The reel 102 of web of a packaging material 2 is spooled from the first rotatable roller 121 into a second reel 104 on the second rotatable roller 122. The arrangement further comprises a sensor 3 for detecting a marking 4 on the packaging material 2, and at least one module 108 which is arranged between the first rotatable roller 121 and the second rotatable roller 122. The marking 4 is provided at a predetermined position on the packaging material 2, i.e. its position is well defined such that the marking may be used as a register mark. The module 108 is used to process the packaging material 2 in any desired way. For this purpose, the arrangement 1 further comprises a control unit 125 which connected to the sensor 3 and the module 108. The control unit 125 is adapted control the module 108 based on the detected marking 4 and/or information stored in the control unit 125. In one preferred embodiment, the sensor 3 reads information stored in the marking 4 and sends the information to the control unit 125. The control unit 125 thereafter compares the information received from the sensor 4 with the information stored in a database of the control unit 125, and instructs the module 108 to process the packaging material 2 based on the result of that comparison. The module 108 can be constituted by any suitable processing means, preferably one, or all, from the group consisting of a guiding unit 110, cutting device 124, splicing unit 120 (see FIGS. 3a and 3b), a waste station 130 (see FIGS. 3a and 3b), a printing device (not shown), an embossing device 13 (see FIG. 4), and an adjusting device (not shown). The arrangement 1 further comprises a third rotatable roller 123. The third roller 123 is used in order to rewind the web of packaging material 2 from the second roller 122 when required.

FIG. 2 illustrates a tension control device 201. A stoppage of the web can generally be performed without major problems, but, on the other hand, problems and disruptions quite often arise in connection with the restart of the web after each stoppage and standstill. Problems and disruptions of this sort are at least partially associated with the fact that a moving web of a packaging material cannot be stopped instantaneously, but rather that a slowdown and stoppage of the web, due to inherent inertia and other dynamic effects, takes place after a continuous retardation process, during which a growing accumulation or loop of the slowing web is formed in conjunction with or immediately before the splicing unit 120. When the web, after its standstill, is then started and reaccelerated, this accumulation or loop of the web will gradually shrink and finally disappear altogether. At the same moment, the web will thus be subjected to an axial pull, which at the same time subjects the web to an instantaneous strong axial force in the motional direction of the web.

In order to prevent this instantaneous axial force from becoming so large that it even exceeds the ultimate tensile strength of the particular web, the arrangement 1 may be equipped with a tension control device 201 according to the invention for controlling axial forces upon a web and keeping these at a level below this ultimate tensile strength.

The tension control device 201 has a first cylinder 204, which is rotatable about a first horizontal shaft, a second cylinder 205, which is rotatable about a second horizontal shaft, and a third rotatable cylinder 203, which is rotatable about a third horizontal shaft. The third rotatable cylinder 203 is movable, in response to axial forces acting upon the web at any moment, between a lower position and an upper position along an arc-shaped motional path (shown in dashed representation) in the vertical plane between the two first and second rotatable cylinders 204 and 205, the arc being defined by the end of the arm 202 that the third cylinder 203 is attached to.

In order to counter strong axial forces upon the web in connection with pulls when the speed of the web is accelerated, the third rotatable cylinder 203 is biased with a freely adjustable force which acts in the direction of the motion of the third cylinder from the lower position. Such a counterforce can be produced in a known manner with both pneumatic and hydraulic and mechanical means which act directly upon the fourth rotatable shaft. In order to avoid rupture of the web due to excessively strong pulls and axial forces upon the web, as is described above, this counterforce must be set at a value below the particular ultimate tensile strength of the web. If the web, for example, has an ultimate tensile strength in the order of magnitude of 20,000 N, then the counterforce can be set at a value amounting to just one tenth ( 1/10) of this, such as 1800-2000 N, in order thus to enable the third cylinder to be displaced, if the web is acted upon by axial forces, already far below the ultimate tensile strength of the web.

FIGS. 3a and 3b illustrate the arrangement 1 according to another exemplary embodiment of the invention. Here, the following modules 108 are included in the arrangement: a guiding unit 110, a cutting device 124, a splicing unit 120, and a waste station 130. The web of packaging material 2 is bent around a present pull- and break arrangement 110 comprises a first cylinder 112 and a second cylinder 114, both being arranged to rotate around a first rotational axis 116 and a second rotational axis 118 respectively. During a doctoring process the operative position of the arrangement 110 is such that the web is guided along an S-shaped path through the arrangement. In the present setup the first cylinder 112 is arranged above the second cylinder 114. The web is guided below and around about half the second cylinder on the far side thereof, as seen from the first reel 102 before following the second cylinder around about half its circumference before continuing towards the doctoring station and the second reel. The first cylinder 112 is illustrated in full lines while various positions for the second cylinder 114 are shown in dotted lines. There is a position P1 corresponding to the position as shown in FIG. 3a; an “operative position”. There is a position P2 which corresponds to an “engagement position” which is more of a position passed when moving between the other positions. There is a “waste position” P3 in which the arrangement will guide a passing web downwards. There is also a “thread position” in which the second cylinder 114 is fully disengaged with the first cylinder 112 such that a web may be conveniently arranged (or thread) through the arrangement 110 merely by following a rectilinear path. The first cylinder 112 is arranged to rotate around a first axis 116. The second cylinder 114 is arranged to rotate around a second axis 118. The first and the second cylinder are arranged in parallel, having parallel rotational axes. In one or more embodiments both cylinders are suspended from one side axial thereof only, basically corresponding to the rotational axis of each cylinder having one end attached to a constructional arrangement while the second end is free.

In the view of FIG. 3b the second cylinder 114 has been arranged in the waste position P3. In this position the second cylinder is in contact with the first cylinder, with the intermediate of the web of packaging material 2, and the tangent of the contact is directed downwards, enabling guiding of the web in an alternative direction. In the present embodiment the web is directed towards a waste assembly schematically indicated by the recycling bin. Wasting of packaging material may be the first operation after threading of a web. This means that the first cylinder is moved from the position P4, to position P2, and then to the waste position P3. One other example could be that the second cylinder is moved from the first position P1 directly to the waste position P3. No matter the scenario the present arrangement nevertheless enables the second cylinder to assume the position P3.

When the automatic repairing process is finished, the packaging material 2 spooled onto the reel 122 is spooled onto the reel 123, see FIG. 3b, so that the packaging material is wound in the same order as when entering the device for removing defects.

FIG. 4 illustrates the arrangement 1 according to another exemplary embodiment of the invention. Here, the module 108 is constituted by an embossing device 13. A web of packaging material 2 is forwarded into the nip 8 between an imprint roller 9 and an anvil roller 10. The protrusions 5 of the imprint roller 9 engages the web of packaging material 1 only when a imprinting area 6 of the imprint roller 9 is facing the web of packaging material 1 and the anvil roller 10. When the non-imprinting area 7 of the imprint roller 9 is facing the web of packaging material 1 and the anvil roller 10, the web packaging material 1 is not engaged with the rollers 9, 10 (i.e. the protrusions 5 of the imprint roller 9 are not in engagement with the web of packaging material 1) and is thereby free to be adjusted. As is seen in FIG. 2, the imprint roller 9 has the cross-section of a truncated circle, where the non-printing area 7 is constituted by the portion of the surface area of the cross-section corresponding to the truncated portion 12. The non-imprinting area 7 is preferably arranged so that it is aligned with a portion of the web package material 1 that is intended for a part of the final package product where no embossing or imprinting is placed, e.g. the bottom or top parts of the package. The sensor 3 which here is used for detecting the alignment of the web of packaging material 2, and is in this embodiment constituted by a camera, is placed so as to detect the position of the marking 4 on the web of packaging material 2. The position of a detected marking 4 is sent to the control unit 125 where it is compared with a database value of an expected position. If any discrepancy in the feeding direction of the web of packaging material 2 is detected, the positioning of the web of packaging material 2 relative the imprint roller 9 is adjusted accordingly by e.g. the tension control device 201 (here in the form of pull and brake rollers). The pull and break rollers are placed on each side of the nip 8 when the non-imprinting area 7 of the imprint roller 9 is facing the web of packaging material 1. The imprint roller 9 is further driven by a motor (not shown) that is controlled by the control unit 125.

Optionally, or in combination with the web positioning described above, the alignment of the web of packaging material 2 is determined by means of the sensor 3 and the control unit 125. Such alignment is preferably analyzed by determining the relative position of the imprinted pattern in view of the position of the register mark(s) 4. If correction is required, e.g. if the actual position of a part of the imprinted pattern is located outside a pre-determined or desired area of the packaging material 2, the control unit 125 is configured to adjust the current rotational position of the imprint roller 9. This is possible due to the truncated circular cross-section of the imprint roller 9. When the imprint roller 9 is in a position in which the non-printing area 7 is facing the web of packaging material 2 it will be possible to rotate the imprint roller 9 slightly without risking engagement between the imprinting area 6 and the web of packaging material 2. In practice this means that when the control unit 125 determines that the location of the imprinted pattern on the web of packaging material 2 deviates from the desired position, a control signal is transmitted to the drive unit (not shown) of the imprint roller 9. Upon receiving the control signal the drive unit is configured to i) determine when the non-imprinting area 7 is facing the web of packaging material 2, and upon this ii) decelerate or accelerate the rotation of the imprint roller 9 slightly such that the subsequent imprint pattern is positioned correctly relative the mark(s) 4.

FIG. 5 illustrates the primary steps of a method for processing a web of a packaging material 2 according to an exemplary embodiment the invention. The method comprises the steps of guiding the web of packaging material 2 between a first rotatable roller 121 and a second rotatable roller 122, detecting a marking 4 on the packaging material 2, wherein the marking 4 is provided at a predetermined position on the packaging material, and processing the packaging material 2 based on the detected marking 4 and/or information stored in a control unit 125.

The skilled person realizes that a number of modifications of the embodiments described herein are possible without departing from the scope of the invention, which is defined in the appended claims.

1. A system for processing a ready-to-use web of a laminated packaging material, the system comprising:
a first rotatable roller and a second rotatable roller, wherein said web of laminated packaging material is wound from said first roller to said second roller;
a sensor configured to detect a marking on said packaging material, said marking located at a predetermined position on said packaging material;
at least one module arranged between said first rotatable roller and said second rotatable roller, said module (108) configured to process said packaging material; and
a controller connected to said sensor and said module, wherein said controller is configured to control said module based on at least one of said detected marking and information stored in said controller.

2. The system according to claim 1, further comprising at least one tension control device configured to provide a pressure in a normal direction to a surface of the web of laminated packaging material and tension the web of laminated packaging material between said first rotatable roller and said second rotatable roller.

3. The system according to claim 1, further comprising a third rotatable roller, wherein said web of laminated packaging material is wound from said second roller to said third roller to rewind said web of laminated packaging material.

4. The system according to claim 1, wherein said information stored in said controller is stored in a database.

5. The system according to claim 1, wherein said at least one module comprises a guiding unit, a cutting device, a splicing unit, a waste station, a printing device, an embossing device, and an adjusting device.

6. (canceled)

7. The system according to claim 5, further comprising an embossing device, said embossing device including:
an anvil roller and an imprint roller arranged adjacent to each other to create a nip therebetween, said imprint roller having a surface area including an imprinting area having protrusions forming an imprinting pattern;
a conveyor arrangement configured to forward said web of said laminated packaging material through said nip to imprint a visual or tactile pattern on the laminated packaging material corresponding to said imprinting pattern on the surface area;
wherein said surface area of said imprint roller further includes a non-imprinting area designed to disengage said nip when said non-imprinting area faces said laminated packaging material.

8. The system according to claim 7, further comprising an adjustment device configured to adjust the position of said laminated packaging material relative to the imprint roller when said non-imprinting area of said surface area faces an outermost layer of said laminated packaging material, wherein the adjustment is based on said marking on said packaging material.

9. The system according to claim 8, wherein adjusting the position of the web relative the imprint roller is performed by adjusting the rotational position of the imprint roller.

10. A method for processing a ready-to-use web of a laminated packaging material, comprising the steps of:
guiding said web of laminated packaging material between a first rotatable roller and a second rotatable roller;
detecting a marking on said packaging material, said marking located at a predetermined position on said packaging material; and
processing said laminated packaging material based on at least one of said detected marking and information stored in a controller.

11. The method according to claim 10, wherein said step of processing said packaging material comprises the following steps:
aligning said web of laminated packaging material;
cutting said web of laminated packaging material;
splicing said web of laminated packaging material;
printing said web of laminated packaging material;
embossing said web of laminated packaging material; and
aligning said web of laminated packaging material.

12. (canceled)

13. The method according to claim 10, wherein said step of processing said laminated packaging material comprises:
forwarding said web of said laminated packaging material through a nip provided between an anvil roller and an imprint roller, wherein the anvil roller and the imprint roller are arranged adjacent to each other, said imprint roller having a surface area including an imprinting area and a non-imprinting area, said imprinting area comprising protrusions forming an imprinting pattern;
imprinting the imprinting pattern into an outermost layer of said laminated packaging material through engagement with said protrusions forming an imprinting pattern as said web of laminated packaging material passes through the nip to form a visual or tactile pattern on the laminated packaging material corresponding to said imprinting pattern of said imprinting area; and
adjusting a position of said web of laminated packaging material relative to the imprint roller when said non-imprinting area of said surface area faces said laminated packaging material.

14. The method according to claim 13, wherein the step of adjusting the position of said web of laminated packaging material relative to the imprint roller is performed in register with said marking on said web of packaging material.

15. The method according to claim 13, wherein adjusting the position of the web of laminated packaging material relative to the imprint roller is performed by adjusting a rotational position of the imprint roller.

16. A ready-to-use laminated packaging material, processed by the method according to claim 13.
